(19) United States
(12) Patent Application Publication
(10) Pub. No.: US 2025/0007809 A1
(43) Pub. Date: Jan. 2, 2025

(54) DYNAMIC PACKET TRACING

(71) Applicant: VMware LLC, Palo Alto, CA (US)

(72) Inventors: Jin Liu, Beijing (CN); Caixia Jiang, Beijing (CN); Xiaoyan Jin, Beijing (CN); Qiong Wang, Beijing (CN); Donghai Han, Beijing (CN)

(21) Appl. No.: 18/222,400

(22) Filed: Jul. 14, 2023

(30) Foreign Application Priority Data
Jun. 27, 2023 (WO) PCT/CN2023/102610

(51) Int. Cl. H04L 43/10

(52) U.S. Cl. CPC H04L 43/10

(57) ABSTRACT

Some embodiments of the invention provide a method for performing dynamic packet tracing in a network that includes a network controller and multiple host computers, each host computer including a set of packet processing stages for processing packet flows in the network. The method is performed for each packet processing stage in the set of packet processing stages at a particular host computer in the network. The method provides to the packet processing stage a set of trace instructions for use in generating a set of trace data when processing packets belonging to a particular packet flow for which a packet tracing operation has been defined. The method receives from the packet processing stage the set of trace data generated during processing of a packet belonging to the particular packet flow. The method determines that the set of trace instructions should be provided to a next packet processing stage in the set of packet processing stages and provides the set of trace instructions to the next packet processing stage.

### BACKGROUND

Today, because the kernel is sensitive to performance, open-tracing architecture is not suitable in the kernel domain of all nodes. When parent-child trace relationships need to be setup between the user space and kernel space, the user space sends trace context into the kernel space, and the kernel space calls a network interface to send out a trace packet. Additionally, because of the wide array of legacy functions of the kernel, static methodologies for adding traces in said legacy functions leads to new trace instruments being inserted into legacy files, and as a result, any mistakes in kernel module compilation will be broken.

### BRIEF SUMMARY

Some embodiments of the invention provide a method for performing dynamic packet tracing in a network. The network, in some embodiments, is a software-defined wide area network (SD-WAN) that includes a network controller and multiple host computers. Each of the host computers includes a set of packet processing stages for processing packet flows in the network. The method is performed in some embodiments by an observer component of a trace monitor implemented on a particular host computer in the network for each packet processing stage in a set of packet processing stages of the particular host computer.

The method provides to the packet processing stage a set of trace instructions for use in generating a set of trace data when processing packets belonging to a particular packet flow for which a packet tracing operation has been defined. In some embodiments, the method provides the set of trace instructions to the packet processing stage by providing a set of trace contextual data. The set of trace contextual data, in some embodiments, includes a unique trace identifier associated with the packet tracing operation, as well as span identifiers associated with each packet processing stage that has processed packets as part of the packet tracing operation. In some embodiments, the set of trace contextual data also includes a parent identifier that identifies the immediately upstream caller to have processed packets as part of the pack tracing operation.

The method receives from the packet processing stage the set of trace data generated during processing of a packet belonging to the particular packet flow. The method determines that the set of trace instructions should be provided to a next packet processing stage in the set of packet processing stages. Based on said determining, the method provides the set of trace contextual data to the next packet processing stage.

In some embodiments, the method determines that the set of trace instructions should be provided to the next packet processing stage based on a set of trace rules defined for the packet tracing operation, and/or a set of trace control settings specified for the packet tracing operation. For instance, in some embodiments, the observer receives, from the network controller, a particular trace control setting specifying to stop the trace at a particular packet processing stage in the set of packet processing stages. After the observer receives a set of trace data from the particular packet processing stage, in some such embodiments, the observer determines that the set of trace instructions should not be provided to the next packet processing stage based on the received particular trace control setting. In some embodiments, the packet processing stages do not yield trace data without having received the set of trace instructions.

In addition to determining that the set of trace instructions should not be provided to the next packet processing stage, the observer also determines based on the received trace control setting that the set of trace contextual data should not be provided to any subsequent packet processing stages. In some embodiments, the particular host computer is a first host computer, and the next packet processing stage is a first packet processing stage of a second host computer. In some such embodiments, when the observer determines that the set of trace instructions should not be provided to any subsequent packet processing stages, the observer does not provide the set of trace instructions to the second host computer. As such, packet processing stages of the second host computer do not yield any trace data as part of the packet tracing operation, according to some such embodiments.

In some embodiments, after receiving a set of trace data from another particular packet processing stage in the set of packet processing stages, the observer determines that based on a particular rule in the set of trace rules, the set of trace instructions should not be provided to a next packet processing stage in the set of packet processing stages. The particular rule, in some embodiments, specifies the set of trace instructions should not be provided to the next packet processing stage when disk capacity of a disk that stores multiple sets of trace data received from packet processing stages of the packet processing pipeline has reached a specified threshold. In addition to stopping the packet tracing operation at the particular packet processing stage, the observer of some embodiments also sends a notification to the network controller indicating disk capacity of the disk has reached the specified threshold. In some embodiments, the network controller provides the notification to an administrator of the network via a UI (user interface) of the network controller.

When the observer determines that a trace should be stopped at a particular packet processing stage, in some embodiments, the packet processing stages to which the set of trace instructions has been provided continue to generate sets of trace data and provide the generated sets of trace data to the observer as these packet processing stages receive and process packets belonging to the particular packet flow. In other embodiments, when the trace is stopped at a particular packet processing stage, such as when a rule condition like the disk capacity rule mentioned above is met, each packet processing stage ceases to generate trace data.

In some embodiments, the trace monitor deployed to the particular host computer aggregates the trace data received from the set of packet processing stages to generate an aggregated set of trace metrics to provide to the network controller. The network controller of some embodiments stores the aggregated set of trace metrics in a database of the network controller. Also, in some embodiments, the network controller provides the aggregated set of trace metrics for display through the UI of the network controller.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIGS. 1A-1B conceptually illustrate diagrams of a computing device of some embodiments before and after an external trace control setting has been received.

FIG. 2 illustrates an example of a UI of some embodiments used to display data associated with a packet tracing session.

FIG. 3 conceptually illustrates a diagram of some embodiments that includes the node from FIGS. 1A-1B and a second node.

FIG. 4 conceptually illustrates a packet tracing process performed in some embodiments.

FIG. 5 conceptually illustrates a diagram of a node of some embodiments that utilizes eBPF technology.

FIG. 6 illustrates a packet processing pipeline of a host computer of some embodiments.

FIG. 7 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for performing dynamic packet tracing in a network. The network, in some embodiments, is a software-defined wide area network (SD-WAN) that includes a network controller and multiple host computers. Each of the host computers includes a set of packet processing stages for processing packet flows in the network. The method is performed in some embodiments by an observer component of a trace monitor implemented on a particular host computer in the network for each packet processing stage in a set of packet processing stages of the particular host computer.

The method provides to the packet processing stage a set of trace instructions for use in generating a set of trace data when processing packets belonging to a particular packet flow for which a packet tracing operation has been defined. In some embodiments, the method provides the set of trace instructions to the packet processing stage by providing a set of trace contextual data. The set of trace contextual data, in some embodiments, includes a unique trace identifier associated with the packet tracing operation, as well as span identifiers associated with each packet processing stage that has processed packets as part of the packet tracing operation. In some embodiments, the set of trace contextual data also includes a parent identifier that identifies the immediately upstream caller to have processed packets as part of the pack tracing operation.

The method receives from the packet processing stage the set of trace data generated during processing of a packet belonging to the particular packet flow. The method determines that the set of trace instructions should be provided to a next packet processing stage in the set of packet processing stages. Based on said determining, the method provides the set of trace contextual data to the next packet processing stage.

In some embodiments, the method determines that the set of trace instructions should be provided to the next packet processing stage based on a set of trace rules defined for the packet tracing operation, and/or a set of trace control settings specified for the packet tracing operation. For instance, in some embodiments, the observer receives, from the network controller, a particular trace control setting specifying to stop the trace at a particular packet processing stage in the set of packet processing stages. After the observer receives a set of trace data from the particular packet processing stage, in some such embodiments, the observer determines that the set of trace instructions should not be provided to the next packet processing stage based on the received particular trace control setting. In some embodiments, the packet processing stages do not yield trace data without having received the set of trace instructions.

In addition to determining that the set of trace instructions should not be provided to the next packet processing stage, the observer also determines based on the received trace control setting that the set of trace contextual data should not be provided to any subsequent packet processing stages. In some embodiments, the particular host computer is a first host computer, and the next packet processing stage is a first packet processing stage of a second host computer. In some such embodiments, when the observer determines that the set of trace instructions should not be provided to any subsequent packet processing stages, the observer does not provide the set of trace instructions to the second host computer. As such, packet processing stages of the second host computer do not yield any trace data as part of the packet tracing operation, according to some such embodiments.

In some embodiments, after receiving a set of trace data from another particular packet processing stage in the set of packet processing stages, the observer determines that based on a particular rule in the set of trace rules, the set of trace instructions should not be provided to a next packet processing stage in the set of packet processing stages. The particular rule, in some embodiments, specifies the set of trace instructions should not be provided to the next packet processing stage when disk capacity of a disk that stores multiple sets of trace data received from packet processing stages of the packet processing pipeline has reached a specified threshold. In addition to stopping the packet tracing operation at the particular packet processing stage, the observer of some embodiments also sends a notification to the network controller indicating disk capacity of the disk has reached the specified threshold. In some embodiments, the network controller provides the notification to an administrator of the network via a UI (user interface) of the network controller.

When the observer determines that a trace should be stopped at a particular packet processing stage, in some embodiments, the packet processing stages to which the set of trace instructions has been provided continue to generate sets of trace data and provide the generated sets of trace data to the observer as these packet processing stages receive and process packets belonging to the particular packet flow. In other embodiments, when the trace is stopped at a particular packet processing stage, such as when a rule condition like the disk capacity rule mentioned above is met, each packet processing stage ceases to generate trace data.

In some embodiments, the trace monitor deployed to the particular host computer aggregates the trace data received from the set of packet processing stages to generate an aggregated set of trace metrics to provide to the network controller. The network controller of some embodiments stores the aggregated set of trace metrics in a database of the network controller. Also, in some embodiments, the network controller provides the aggregated set of trace metrics for display through the UI of the network controller.

A tracing feature of some embodiments accurately identifies the root cause of issues and easily retrieves some temporarily volatile runtime data by controlling dynamic traces in a distributed environment. The tracing feature of some embodiments can efficiently shrink large traces when they are not needed. In some embodiments, when certain conditions defined are hit, the system automatically generates valid and useful trace data for use in troubleshooting. The system effectively balances the amount of trace yield and validation of data.

In some embodiments, dynamic traces are controlled in various network virtualization platform components and the development is reduced to increase flexibility. A new function module is added in some embodiments to a common network virtualization platform trace component, referred to herein as the observer. The observer is responsible for dynamic trace yield based on flexible rules, in some embodiments. The tracer component of some embodiments is responsible for handling trace generation requests and relaying context of the parent trace. As long as a workflow starts, all trace methods will yield their trace data, in some embodiments, except in the case of an abnormal halt in the workflow.

When a workflow starts, in some embodiments, the observer handles trace control settings provided from external sources as well as internal trace control rules in order to determine whether context of the parent trace should be relayed to the next child. If no trace context is dispatched, the subsequent trace data is not yielded, according to some embodiments. External trace control settings and internal trace control rules, in some embodiments, are a kind of check-conditions. For example, when an exception occurs, the subsequent trace will not be yielded, in some embodiments, or when a particular error is traced, two or more child traces are generated with detailed runtime data, according to some embodiments.

In some embodiments, each trace includes one or more spans. The spans are individual segments of work in the trace, in some embodiments. The spans, in some embodiments, are fundamental units of trace data. In some embodiments, spans are identified, described, organized, and displayed using Operation for Applications Span format that includes fields and span tags for capturing span attributes. The Operations for Applications Span is representative of time spent by an operation in a service. The service, in some embodiments, is a microservice, which is an architectural pattern that breaks up the functions of an application into a set of small, discrete, decentralized, goal-oriented processes that can be independently developed, tested, deployed, replaced, and scaled in some embodiments.

In some embodiments, spans in a trace have parent-child relationships to other spans in the trace. Such parent-child relationships exist between spans, in some embodiments, when an operation passes data or control to another operation. These operations can be in the same service or in different services, according to some embodiments. Parent spans that have multiple child spans represent requests that invoke multiple operations (e.g., parallel operations or serial operations), in some embodiments. Each member span in a span trace for a trace, in some embodiments, shares a unique trace identifier assigned to the trace.

Because trace identifiers can be long and are not typically displayed, in some embodiments, traces are referred to by the service and operation of their root spans (i.e., the spans from the initial trace requests). As such, in some embodiments, different traces have the same label when different calls are made to the same operation. Traces having the same label can still be distinguished by their unique trace identifiers, as well as by their differing start times and durations, according to some embodiments.

Certain span fields, in some embodiments, are required. Examples of required span fields of some embodiments include operation name (“operationName”), which is a name of the operation represented by the span; source, which is the name of a host or container on which the operation executes; span tags (“spanTags”), which are special tags associated with a span; start time (“start_milliseconds), which is the start time of the span expressed as Epoch time; and duration (“duration_milliseconds”), which is the duration of the span.

The span tags, in some embodiments, are key-value pairs and can include required span tags and optional span tags. In some embodiments, the required span tags are necessary for the span to be valid. Optional span tags of some embodiments can include custom span tags, and cannot use reserved span tag names. The maximum length of a span tag key is 128, in some embodiments, and if the span tag key exceeds this maximum length, the associated span is blocked (e.g., by the Operations for Applications service), in some embodiments. The maximum length of a span tag value is also 128, in some embodiments, and if exceeded, in some embodiments, the value is truncated to the maximum length.

In some embodiments, certain identifying span tags are required, such as the unique trace identifier assigned to a trace to which a span belongs, as well as a span identifier, that uniquely identifies the span. An example of an optional identifying span tag, in some embodiments, is a parent span tag that identifies a span's dependent parent, if any. In addition to identifying span tags, some embodiments also include filtering span tags that are used to aggregate and filter trace data at different levels of granularity. Examples of required filtering span tags of some embodiments include an application span tag that names the application or service emitting the span, a service span tag that names the microservice emitting the span, a cluster span tag that names the group of related hosts that serves as a cluster or region in which the application or service runs (or “cluster-none” for spans that do not use this span tag), and a shard span tag that names a subgroup of hosts within the cluster (e.g., a mirror) (or “shard-none” for spans that do not use this span tag).

Each trace is defined, in some embodiments, by a user (e.g., administrator) through a network management and control system. For example, in some embodiments, traces are defined via an application programming interface (API) entry point provided by the network management and control system. In some embodiments, packet traces are defined as part of user-defined live packet monitoring sessions, which, in some embodiments, specify additional actions such as packet capture and packet counting. Each user-defined live packet monitoring session, and subsequently each user-defined packet tracing session, specifies a source machine or source interface that corresponds to a machine from which packets of interest are sent.

In some embodiments, packets of interest are processed by one or more packet processing pipelines. Each packet processing pipeline, in some embodiments, includes a set of packet processing stages executed by one or more computing devices (e.g., host computers, edge devices, etc.) to perform various packet processing operations on packets. Examples of packet processing stages of some embodiments include but are not limited to ingress and egress packet processing stages, a firewall stage, logical switching and/or routing stages, a quality of service (QOS) stage, a network address translation (NAT) stage, and encapsulation/decapsulation stages. The stages of a given packet processing pipeline are performed, in some embodiments, by one or more forwarding elements (e.g., software forwarding elements (SFEs)) and/or other modules (e.g., firewall engines, filter engine, etc.) executing on the computing device (e.g., in virtualization software of the computing device).

An initial stage of each packet processing pipeline, such as the ingress stage or a filtering stage (e.g., using an eBPF (extended Berkeley Packet Filter)), is configured, in some embodiments, to match packets against a specified set of characteristics (e.g., characteristics specified for a packet tracing session) and tag matching packets to indicate the packets are part of a packet tracing session (e.g., by setting a flag on a packet or writing into a packet's metadata). In some embodiments, the set of characteristics can include a flow identifier (e.g., a five-tuple identifier) and/or a source of packets of interest (e.g., a source machine or source interface that corresponds to a source machine). As mentioned above, packet tracing sessions are defined as part of live monitoring sessions that, in some embodiments, specify additional actions, such as packet capture and packet counting. In some such embodiments, the initial stage tags packets for each action (i.e., tracing, capturing, and/or counting) specified for characteristics of the packets.

In some embodiments, as stages of the packet processing pipeline of a computing device in a network process packets tagged as part of a packet tracing session, the stages provide trace data collected and/or generated during processing of a packet to a trace monitor on the computing device that communicates with a network controller for the network. The trace monitor, in some embodiments, includes an observer component that determines whether a trace should continue or be stopped based on a set of internal trace rules, external control settings, and the received trace data.

Each packet processing stage, in some embodiments, only performs tagged actions supported by the stage when the observer component provides trace instructions to the packet processing stage. The trace instructions, in some embodiments, include trace context such as a trace identifier associated with the packet tracing session, one or more span identifiers of the spans that have processed packets as part of the overall tracing operation, and, in some embodiments, a parent span identifier that is the span identifier of the immediately upstream caller (e.g., the most recent stage to have processed the packet).

In some embodiments, the observer component includes the monitoring actions to be performed on packets that are part of the tracing operation in the trace instructions provided to each packet processing stage. That is, rather than an initial packet processing stage tagging packets with the monitoring actions to be performed on those packets, each packet processing stage receives trace context from the observer component that specifies one or more monitoring actions to perform on a packet, as well as the trace identifier, span identifiers, and parent identifier mentioned above, in some embodiments. Each packet processing stage then determines which actions specified in the trace instructions are supported by the stage, in some embodiments, and performs the supported actions on the packet.

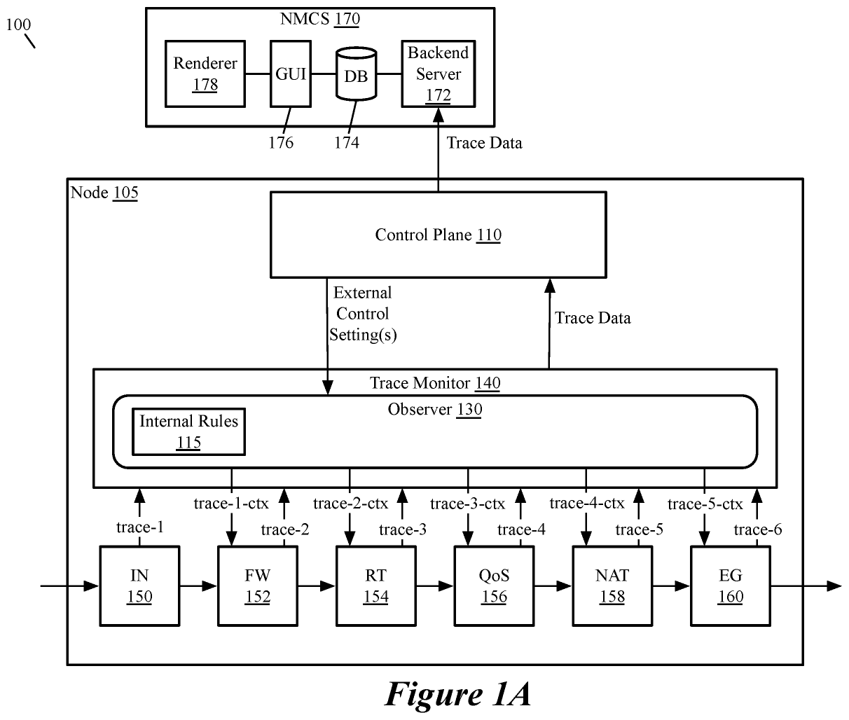

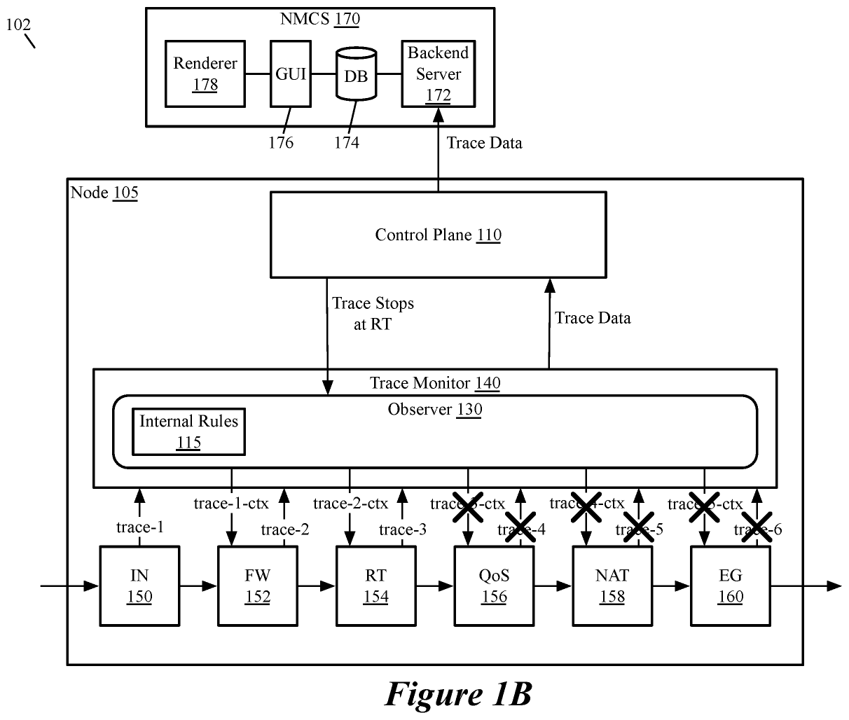

FIG. 1A conceptually illustrates a diagram 100 of a computing device of some embodiments that includes packet processing stages, a trace monitor, and an observer for performing packet tracing operations. As shown, the diagram 100 includes a node 105 and a network management and control system (NMCS) 170. The node 105 includes a control plane 110, a trace monitor 140, and a packet processing pipeline that includes an ingress stage 150, a firewall stage 152, a routing stage 154, a QoS stage 156, a NAT stage 158, and an egress stage 160. Additionally, the trace monitor 140 includes an observer 130 that includes internal rules 115. The NMCS 170 includes a backend server 172, a database 174, a GUI (graphical user interface) 176, and a renderer 178.

In some embodiments, the trace monitor 140 is a data plane trace monitor that is configured to monitor the packet processing stages 150-160. The trace monitor 140 of some embodiments communicates with the NMCS 170 via the control plane 110 to receive packet tracing rules and to provide packet tracing results as the trace monitor 140 receives trace data from the packet processing stages 150-160. As mentioned above, the trace monitor 140 of some embodiments is responsible for handling trace generation requests (e.g., API requests specifying user-defined traces) and relaying context of the parent trace to each packet processing stage. In other embodiments, the observer component 130 is responsible for relaying context of the parent trace to each packet processing stage.

In some embodiments, as long as a workflow starts, all trace methods (i.e., all packet processing stages that are included as part of a packet tracing session) yield their trace data, except in the case of an abnormal halt in the workflow. As will be further described below, such as by reference to FIG. 1B, traces can also be stopped, in some embodiments, by the observer component 130 based on the internal trace rules 115 and/or based on external control settings (e.g., received from the NMCS 170). In some such embodiments, when the observer component 130 determines a trace should not continue, the observer component 130 stops providing trace context to subsequent stages of the packet processing pipeline. Without the trace context, the subsequent stages do not generate trace data to provide to the trace monitor 140 and observer 130, according to some embodiments.

In some embodiments, the trace monitor 140 aggregates the trace data to provide aggregated packet tracing results to the NMCS 170. For instance, in some embodiments, the trace monitor 140 publishes consolidated, per-flow packet tracing results to the control plane 110 for collection by the backend server 172 of the NMCS 170. Once the backend server 172 collects the packet tracing results from the control plane 110, the back server 172 persists the collected results to the database 174. The GUI 174 polls the database 172 for the packet tracing results and, in some embodiments, calls the renderer 178 to display the results for viewing by a user (e.g., administrator). The displayed results, in some embodiments, include names of the stages that have processed the packets, amount of processing time by each stage, and other details regarding the packet tracing session.

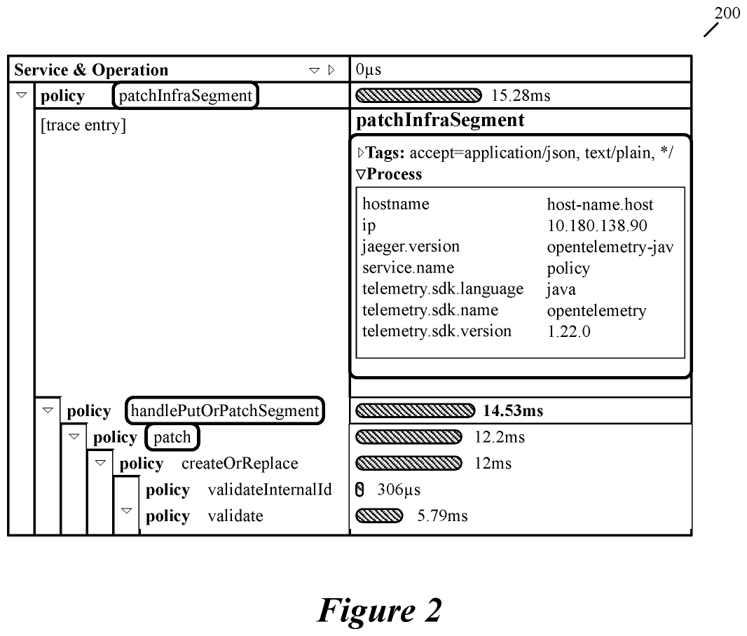

FIG. 2 illustrates an example of a UI 200 of some embodiments used to display data associated with a packet tracing session. As shown, the UI 200 specifies a host name, host IP (Internet Protocol) address, version, service name, SDK language, SDK name, and SDK version. Additionally, the UI 200 specifies different operations (e.g., stages), and their associated durations for completing requests. For example, the first policy operation, “patchInfraSegment” has an associated duration of 15.28 milliseconds.

As also mentioned above, when a workflow starts, in some embodiments, the observer 130 handles trace control settings provided from external sources (e.g., from the NMCS 170 via the control plane 110), as well as internal trace control rules in order to determine whether context of a parent trace should be relayed to a next child. That is, as each packet processing stage provides trace data to the trace monitor 140, the observer 130 determines whether trace context (e.g., trace instructions) used by each stage to collect and/or generate data for the packet tracing session should be provided to the next stage in the pipeline, or whether the packet tracing session should end with the most recent stage from which trace data has been received.

The trace context of some embodiments includes a trace identifier associated with the overall trace, span identifiers of each stage that has already generated trace data for the trace, a parent identifier of the immediately upstream stage to have generated trace data for the trace, and, in some embodiments, one or more monitoring actions to be performed on traced packets (e.g., packet capture, packet counting, etc.). When the observer 130 does not dispatch trace context to the next stage, subsequent trace data is not yielded by the next stage, or any subsequent stages that also do not receive the trace context, according to some embodiments.

External trace control settings and internal trace control rules, in some embodiments, are check-conditions utilized by the observer 130 to determine whether a trace should be stopped following a particular stage or whether the trace should be continued. For example, when an exception occurs, the subsequent trace will not be yielded, in some embodiments, or when a particular error is traced, two or more child traces are generated with detailed runtime data, according to some embodiments. In some embodiments, the external trace control settings are defined by a user through the NMCS 170 and provided to the observer 130 via the control plane 110 during runtime to prevent trace context from being dispatched to subsequent packet processing stages, or to ensure the trace context is dispatched to subsequent packet processing stages.

FIG. 1B, for instance, illustrates a diagram 102 showing the node 105 of FIG. 1A after an external trace control setting has been received, in some embodiments. As shown, the observer 130 receives the external control setting indicating the trace should stop at the routing stage 154 via the control plane 110. As a result, the observer 130 does not relay trace context to the QoS stage 156, effectively stopping the trace after the routing stage 154.

Because the trace is stopped, and the trace context is not dispatched to any stages after the routing stage 154, trace data is not yielded from the QoS stage 156, the NAT stage 158, or the egress stage 160. While the subsequent stages 156-160 do not yield any trace data, stages 150-154 continue to yield trace data and provide trace data to the trace monitor 140 as the stages 150-154 receive and process packets that are part of the packet tracing session.

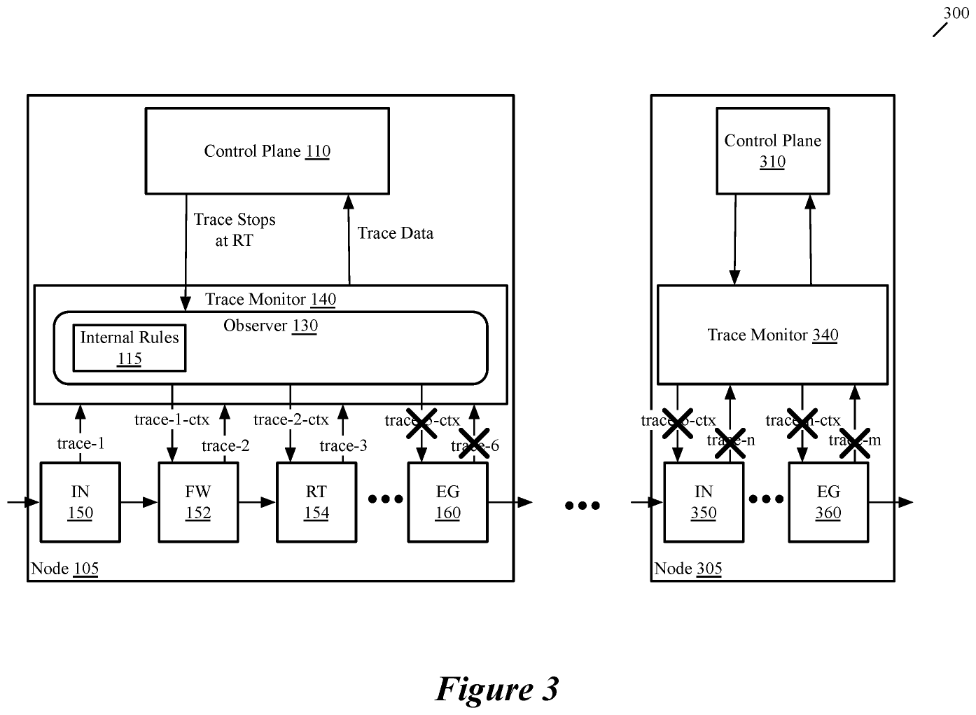

In some embodiments, when a trace is stopped at a particular stage on a particular node, the trace is also effectively stopped for each additional node that may process packets of interest subsequent to the node 105. FIG. 3 conceptually illustrates a diagram 300 of some embodiments that includes the node 105 from FIGS. 1A-1B and a second node 305. The node 305 includes a control plane 310, trace monitor 340, and packet processing stages 350 and 360.

In this example, because the observer 130 on the node 105 has received the external trace control setting indicating the trace stops at stage 154, subsequent stages on the node 105, as well as the stages on the node 305 do not receive the trace context needed to continue the trace and yield trace data, and thus, no additional trace data is yielded on either node 105 or node 305 following stage 154 on the node 105, nor on any intermediate nodes (e.g., forwarding devices) that may exist between nodes 105 and 305.

In some embodiments, when the trace is continued between nodes, the trace context is provided from one node to the next via an RPC (remote procedure call) request that includes the trace identifier associated with the packet tracing session, span identifiers of the spans that have processed packets as part of the overall trace, and, in some embodiments, a parent span identifier that is the span identifier of the immediately upstream caller (e.g., the most recent stage to have processed the packet).

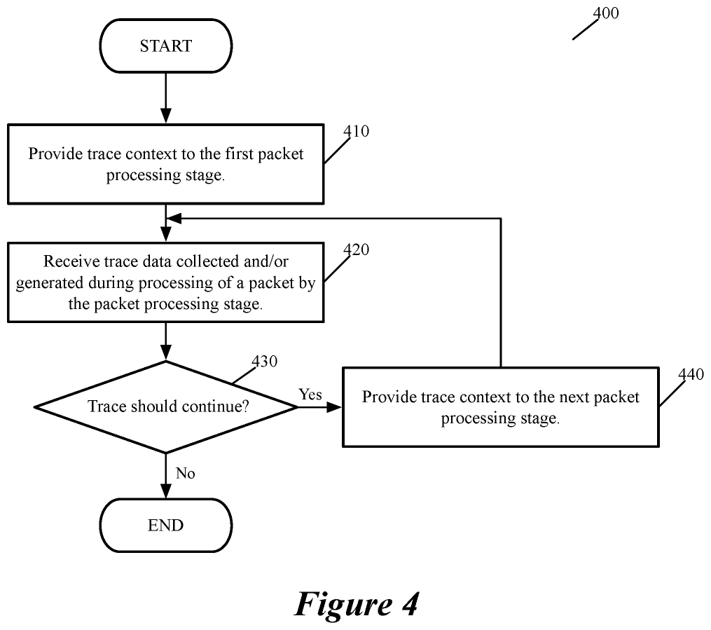

FIG. 4 conceptually illustrates a packet tracing process performed in some embodiments. The process 400 is performed, in some embodiments, by an observer component of a trace monitor on a computing device, such as the observer 130 of the trace monitor 140 described above. The process 400 starts when the observer provides (at 410) trace context to the first packet processing stage in a packet processing pipeline.

The trace context, in some embodiments, allows each packet processing stage to yield trace data as part of the packet processing session. The trace context, in some embodiments, includes at least a trace identifier associated with the packet tracing session, as well as span identifiers of the spans that have processed packets as part of the packet tracing session. When applicable, the trace context of some embodiments also includes a parent span identifier that is the span identifier of the immediately upstream caller (e.g., the most recent stage to have processed the packet).

In addition to the identifiers, the trace context of some embodiments also includes one or more actions to perform on traced packets. When a packet processing stage is provided the trace context, in some embodiments, the packet processing stage determines whether it supports any of the actions specified, and performs the supported actions. Examples of monitoring actions, in some embodiments, include packet tracing, packet capture, and packet counting. In some embodiments, each stage of each packet processing pipeline that supports packet tracing creates a record for each packet that it processes when packet tracing is specified as a monitoring action for the packet. Aggregating the resulting packet metrics, in some embodiments, produces the path traversed by the packet between its source and destination as well as aggregated metrics.

Stages of packet processing pipelines that support packet capture intercept packets tagged for packet capture, and temporarily store the captured packets for analysis. In some embodiments, analyzing packets using packet capture can be useful for granting visibility in order to identify and/or troubleshoot network issues. Packet counting, in some embodiments, provides insight into how many packets (and/or how much data) are received and processed by each packet processing pipeline of each computing device traversed by packet flows for which the live packet monitoring session is performed. In some embodiments, packet count can be useful for identifying packet loss, as well as which packets are being dropped based on packet identifiers associated with the packets. Other monitoring actions in some embodiments may include packet flow statistics accumulation, packet latency measurement, or other packet monitoring measurements. It should be understood that the examples given in this document are not exhaustive of the types of monitoring actions that could be incorporated into the described framework.

Returning to the process 400, the process receives (at 420) trace data collected and/or generated during processing of a packet by the packet processing stage. In some embodiments, the trace data includes information such as the number of requests completed by the stage per second, the number of failed requests per second (e.g., as a percentage of total requests per second), and duration of the request (e.g., amount of time taken to complete the request).

The process 400 determines (at 430) whether the trace should continue based on internal trace rules and external trace control settings. That is, after trace data has been received and before trace context is provided to the next packet processing stage, the observer determines whether the trace context should be provided to the next packet processing stage based on internal trace rules and external trace control settings.

For example, a packet tracing session of some embodiments can be defined according to a set of parameters, and during runtime of the packet tracing session, the parameters can be dynamically modified to alter the packet tracing session, such as to stop the trace at a particular stage, to add additional child traces (e.g., specify additional stages that should collect and/or generate trace data to provide to the trace monitor), etc. In some embodiments, the internal rules can include rules defined to stop a trace when, e.g., disk capacity reaches a particular percentage (e.g., 80% capacity) to prevent impacts to services, and to notify a user (e.g., administrator) of the disk's capacity by sending a notification to a network controller (e.g., the NMCS 170).

When the process 400 determines that the packet tracing session should continue, the process 400 provides (at 440) the trace context (e.g., trace instructions) to the next packet processing stage in the packet processing pipeline. In some embodiments, the observer updates the trace context with an updated span identifier and, if applicable, adds a new parent identifier (e.g., identifier of a first service when forwarding to a second service) before forwarding the trace context to the next stage. The process 400 then returns to receive (at 420) trace data from the packet processing stage. When the process 400 determines that the packet tracing session should not continue, the process 400 ends.

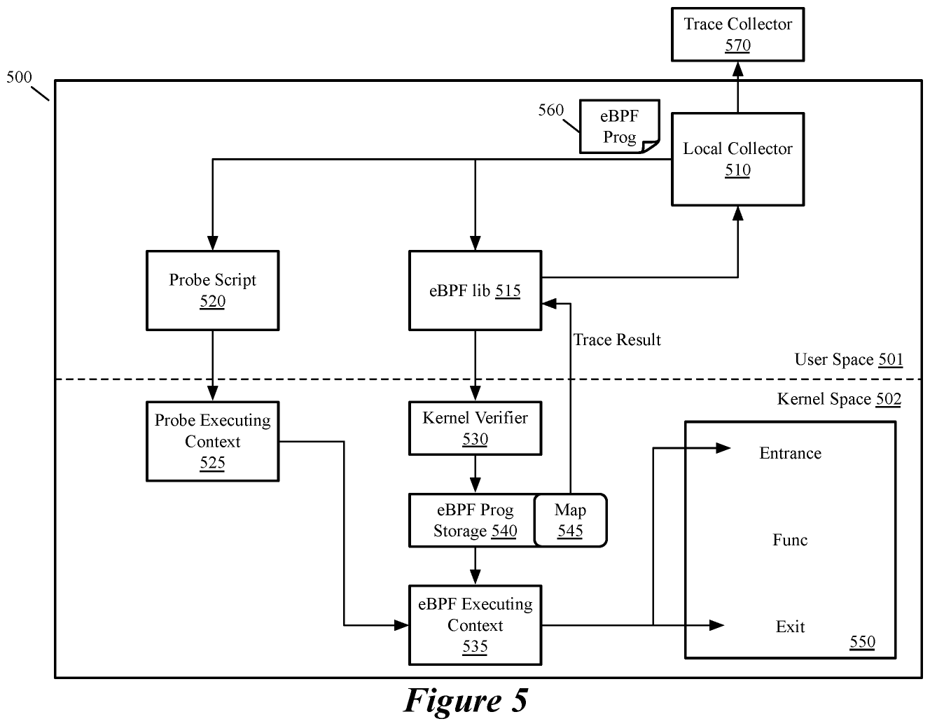

To evolve trace development, some embodiments take advantage of dynamic tools. In some embodiments, eBPF technology is utilized for kernel trace development. FIG. 5 conceptually illustrates a diagram of a node 500 of some embodiments that utilizes eBPF technology. The node 500 includes a user space 501 and a kernel space 502. The user space 501 includes a local collector 510, an eBPF library 515, and a probe script 520. The kernel space 502 includes a probe executing context 525, a kernel verifier 530, an eBPF program storage 540 and map 545, an eBPF executing context 535, and trace points 550.

In some embodiments, each traced kernel interface adds two trace points 500. The first trace point is a function entrance, and the second trace point is a function exit. In some embodiments, the probing tool (e.g., probe script 520 and probe executing context 525) helps to add dynamic tracing points 550 to these functions.

To add a trace, some embodiments first identify a trace point 550 in a source file (e.g., a declared function). Next, in some embodiments, trace business is added, such as by creating a trace at the function entrance and a dispatch at the function exit. The source package is then recompiled to get binary with trace enablement, and the binary is rerun to generate trace data. These steps are repeated (e.g., N number of times) to yield new trace data, according to some embodiments.

The eBPF program 560 of some embodiments provides the availability to propagate trace context in a thread-local storage 540 and to compose the information. The eBPF program 560 is provided by the local collector 510 to the probe script 520 and to the eBPF library 515. The eBPF library 515 provides the eBPF program 560 to the kernel verifier 530 (e.g., an eBPF verifier). The kernel verifier 530 verifies the eBPF programs at load time and rejects any programs that it determines to be unsafe, in some embodiments. Once the kernel verifier 530 has verified the eBPF program 560, the eBPF program 560 is stored in the eBPF program storage 540.

As trace context is received and propagated to the storage 540 to compose the information from the trace context, the composed information is then stored into the eBPF map 545, in some embodiments. The eBPF map 545 is shared, in some embodiments, with the local collector 510. In some embodiments, the local collector 510 calls the file descriptor, eBPF library 515, of the map 545 to obtain the span data and then export the span data to a trace collector 570 (e.g., Wavefront).

In some embodiments, for application trace development, AOP (Aspect Oriented Programming) technology is utilized. Like eBPF, trace points in AOP are defined via static description in configuration files. During runtime, in some embodiments, the pointcuts are executed around the methods designated (e.g., the packet processing stages designated) and generate trace data.

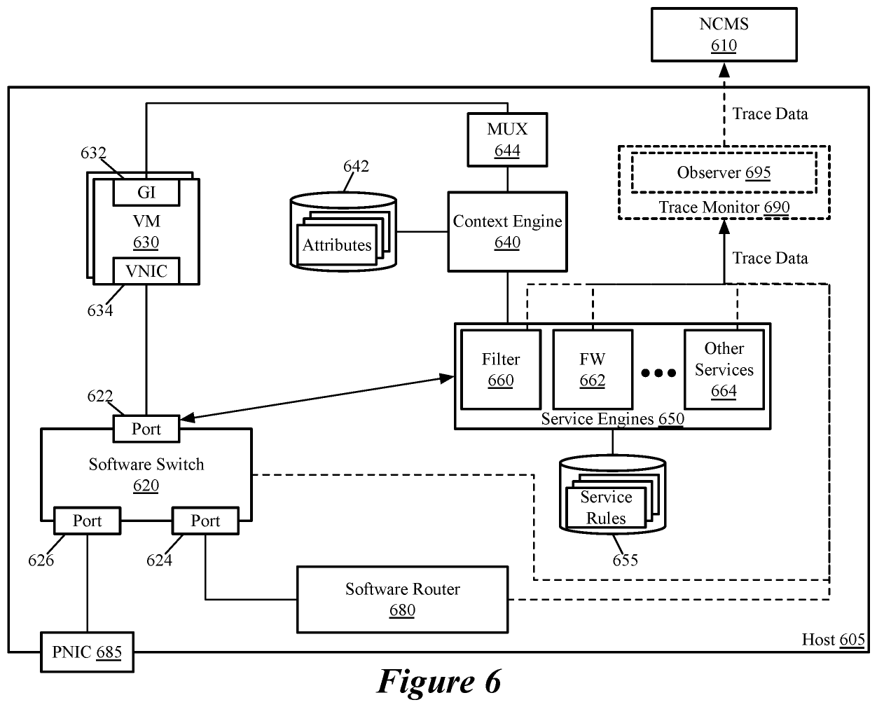

FIG. 6 illustrates a packet processing pipeline of a host computer of some embodiments. The host computer 605 includes a software switch 620, a software router 680, VMs 630, a context engine 640, an attributes storage 642, a MUX (multiplexer) 644, service engines 650, a service rules storage 655, a trace monitor 690, and a PNIC 685. The software switch 620 includes port(s) 622 for connecting to the VMs 630, a port 624 for connecting to a software router 680, and a port 626 for connecting to a physical network interface card (PNIC) 685 of the host computer 605. In some embodiments, the context engine 640, the software switch 620, the software router 680, the service engines 650, the service rules storage 655, and the MUX 644 operate in the kernel space of a hypervisor, while the VMs 630 operate in the user space of the hypervisor. In other embodiments, one or more service engines are user space modules (e.g., are service VMs).

The VMs 630, in some embodiments, serve as data endpoints in a datacenter. While illustrated as VMs in this example, the VMs 630 in other embodiments are machines such as webservers, application servers, database servers, etc. In some embodiments, all of the VMs belong to one entity (e.g., an enterprise that operates on the host computer 605), while in other embodiments, the host computer 605 operates in a multi-tenant environment (e.g., in a multi-tenant datacenter), and different VMs 630 may belong to one tenant or to multiple tenants. In addition, as mentioned above, in some embodiments at least some of these endpoint machines may be containers, pods, or other types of data compute nodes rather than VMs.

Each of the VMs 630 includes a GI agent 632 that interacts with the context engine 640 to provide contextual attribute sets to this engine and to receive instructions and queries from this engine. Each GI agent 632, in some embodiments, registers with notification services of its respective endpoint machine to receive notifications regarding newly launched processes and/or previously launched processes on their endpoint machines, and/or regarding new message flows sent by or received for their endpoint machine. As shown, all communications between the context engine 640 and the GI agents 632 are relayed through the MUX 644, in some embodiments. An example of such a MUX is the MUX that is used by the Endpoint Security (EPSec) platform of ESX hypervisors of VMware, Inc.

In some embodiments, the GI agents 630 communicate with the MUX 644 through a fast communication channel (e.g., a virtual machine communications interface channel). This communication channel, in some embodiments, is a shared memory channel. In some embodiments, the attributes collected by the context engine 640 from the GI agents 632 include a rich group of parameters (e.g., layer 7 parameters, process identifiers, user identifiers, group identifiers, process name, process hash, loaded module identifiers, consumption parameters, etc.).

In addition to the GI agents 632, each VM 630 includes a virtual network interface card (VNIC) 634, in some embodiments. Each VNIC is responsible for exchanging packets between its VM and the software switch 620 and connects to a particular port 622 of the software switch. In some embodiments, the software switch 620 maintains a single port 622 for each VNIC of each VM. As mentioned above, the software switch 620 also includes a port 624 that connections to the software router 680, and a port 626 that connects to the PNIC 685 of the host computer 605. In some embodiments, the VNICs are software abstractions of one or more PNICs 685 of the host computer that are created by the hypervisor.

The software switch 620 connects to the host PNIC (through a network interface card (NIC) driver (not shown)) to send outgoing packets and to receive incoming packets. In some embodiments, the software switch 620 is defined to include a port 626 that connects to the PNIC's driver to send and receive packets to and from the PNIC 685. The software switch 620 performs packet-processing operations to forward packets that it receives on one of its ports to another one of its ports. For example, in some embodiments, the software switch 620 tries to use data in the packet (e.g., data in the packet header) to match a packet to flow-based rules, and upon finding a match, to perform the action specified by the matching rule (e.g., to hand the message to one of its ports 622, 624, or 626, which directs the packet to be supplied to a destination VM, the software router, or the PNIC).

The software router 680, in some embodiments, is a local instantiation of a distributed virtual router (DVR) that operates across multiple different host computers and can perform layer 3 (L3) packet forwarding between VMs on a same host or on different hosts. In some embodiments, a host computer may have multiple software routers connected to a single software switch (e.g., software switch 620), where each software router implements a different DVR.

The software router 680, in some embodiments, includes one or more logical interfaces (LIFs) (not shown) that each serves as an interface to a particular segment (virtual switch) of the network. In some embodiments, each LIF is addressable by its own IP address and serves as a default gateway or ARP proxy for network nodes (e.g., VMs) of its particular segment of the network. All of the different software routers on different host computers, in some embodiments, are addressable by the same “virtual” MAC address, while each software router is also assigned a “physical” MAC address in order to indicate on which host computer the software router operates.

In some embodiments, the software switch 620 and the software router 680 are a combined software switch/router. The software switch 620 in some embodiments implements one or more logical forwarding elements (e.g., logical switches or logical routers) with software switches executing on other host computers in a multi-host environment. A logical forwarding element, in some embodiments, can span multiple hosts to connect VMs that execute on different hosts but belong to one logical network.

Different logical forwarding elements can be defined to specify different logical networks for different users, and each logical forwarding element can be defined by multiple software forwarding elements on multiple hosts. Each logical forwarding element isolates the traffic of the VMs of one logical network from the VMs of another logical network that is serviced by another logical forwarding element. A logical forwarding element can connect VMs executing on the same host and/or on different hosts. In some embodiments, the software switch 620 extracts from a packet a logical network identifier (e.g., a VNI) and a MAC address. The software switch in these embodiments uses the extracted VNI to identify a logical port group, and then uses the MAC address to identify a port within the identified port group.

Software switches and software routers (e.g., software switches and software routers of hypervisors) are sometimes referred to as virtual switches and virtual routers because they operate in software. However, in this document, software switches may be referred to as physical switches because they are items in the physical world. This terminology also differentiates software switches/routers from logical switches/routers, which are abstractions of the types of connections that are provided by the software switches/routers. In some embodiments, the ports of the software switch 620 include one or more function calls to one or more modules that implement special input/output (I/O) operations on incoming and outgoing packets that are received at the ports. Examples of I/O operations that are implemented by the ports 622 include ARP broadcast suppression operations and DHCP broadcast suppression operations, as described in U.S. Pat. No. 9,548,965.

Other I/O operations (e.g., firewall operations, load-balancing operations, network address translation (NAT) operations, traffic monitoring operations, etc.) can also be implemented. For example, the service engines 650 include a filtering stage 660 for tagging packets of interest for packet tracing sessions (and other traffic monitoring sessions), a firewall stage 662, and other services stage 664. By implementing a stack of such function calls, the ports can implement a chain of I/O operations on incoming and/or outgoing packets, in some embodiments. In some embodiments, each of the service engines 650 provides trace data to the trace monitor 690.

In addition to the function call operations of the service engines 650, other modules in the datapath implement operations for which trace data is provided to the trace monitor 690 as well. For example, the software switch 620 and the software router 680 also provide trace data to the trace monitor 690 when applicable. As the trace data is provided to the trace monitor 690, assuming the observer 695 does not stop the packet tracing session, the trace monitor 690 provides the trace data to the NCMS 610, in some embodiments.

In some embodiments, one or more function calls of the software switch ports 622 can be to one or more service engines 650 that process service rules in the service rules storage 655 and that collect and/or generate trace data for trace monitoring session. While illustrated as sharing one service rules storage 655, in some embodiments, each service engine 650 has its own service rules storage 655. Also, in some embodiments, each VM 630 has its own instance of each service engine 650, while in other embodiments, one service engine can service packet flows for multiple VMs on a host (e.g., VMs for the same logical network).

To perform its configured service operation(s) for a packet flow, a service engine 650 in some embodiments tries to match the flow identifier (e.g., five-tuple identifier) and/or the flow's associated contextual attribute set to the match attributes of its service rules in the service rules storage 655. Specifically, for a service engine 650 to perform its service check operation for a packet flow, the software switch port 622 that calls the service engine supplies a set of attributes of a packet that the port receives. In some embodiments, the set of attributes are packet identifiers, such as traditional five-tuple identifiers. In some embodiments, one or more of the identifier values can be logical values that are defined for a logical network (e.g., can be IP addresses defined in a logical address space). In other embodiments, all of the identifier values are defined in the physical domains. In still other embodiments, some of the identifier values are defined in the logical domain, while other identifier values are defined in the physical domain.

A service engine 650, in some embodiments, then uses the received packet's attribute set (e.g., five-tuple identifier) to identify a contextual attribute set for the flow. In some embodiments, the context engine 640 supplies the contextual attributes for new flows (i.e., new network connection events) sent or received by the VMs 630, and for new processes executing on the VMs 630, to the service engines 650, along with a flow identifier or process identifier. In some embodiments, the service engines 650 pull the contextual attribute sets for a new flow or new process from the context engine. For instance, in some embodiments, a service engine supplies a new flow's five-tuple identifier that it receives from the software switch port 622 to the context engine 640, which then examines its attributes storage 642 to identify a set of attributes that is stored for this five-tuple identifier, and then supplies this attribute set (or a subset of it that it obtains by filtering the identified attribute set for the service engine) to the service engine.

After identifying the contextual attribute set for a data message flow or process, the service engine 650, in some embodiments, performs its service operation based on service rules stored in the service rules storage 655. To perform its service operation, the service engine 650 compares the received attribute set with the match attribute sets of the service rules to attempt to find a service rule with a match attribute set that matches the received attribute set.

The match attributes of a service rule, in some embodiments, can be defined in terms of one or more layer 2 (L2) through layer 4 (L4) header parameters, as well as contextual attributes that are not L2-L4 header parameters (e.g., are layer 7 (L7) parameters, process identifiers, user identifiers, group identifiers, process name, process hash, loaded module identifiers, consumption parameters, etc.). Also, in some embodiments, one or more parameters in a rule identifier can be specified in terms of an individual value or a wildcard value. In some embodiments, a match attribute set of a service rule can include a set of individual values or a group identifier, such as a security group identifier, a compute construct identifier, a network construct identifier, etc.

In some embodiments, to match a received attribute set with the rules, the service engine compares the received attribute set with the associated match attribute sets of the service rules stored in the service rules storage 655. Upon identifying a matching rule, the service engine 650 performs a configured service operation (e.g., a firewall operation), based on the action parameter set (e.g., based on Allow/Drop parameters) of the matching rule. The service rules storage 655, in some embodiments, is defined in a hierarchical manner to ensure that a packet rule check will match a higher priority rule before matching a lower priority rule, when the packet's attribute subset matches multiple rules. In some embodiments, the context-based service rule storage 642 includes a default rule that specifies a default action for any packet rule check that cannot identify any other service rules. Such a default rule will be a match for all possible attribute subsets, in some embodiments, and ensures that the service engine will return an action for all received attribute sets. In some embodiments, the default rule will specify no service.

For packets having the same packet identifier attribute sets (e.g., packets belonging to the same flow), the service engine of some embodiments stores any service rules matching the attribute sets in a connection state cache storage (not shown) for later use on subsequent packets of the same packet flow. This connection state cache storage, in some embodiments, stores the service rule, or a reference to the service rule. In some embodiments, the rule or reference to the rule is stored with an identifier (e.g., the flow's five-tuple identifier and/or a hash value of the same) that is generated from the matching packet identifier set. In some embodiments, a service engine 650 checks this connection state cache storage before checking the service rule storage 655 in order to determine if any service rules have been identified for packets belonging to the same flow. If not, the service engine checks the rules storage 655.

In some embodiments, the other services 664 service engine includes a deep packet inspector for performing deep packet inspection (DPI) on packets to identify a traffic type (i.e., the application on the wire) that is being sent in this packet flow, generates an AppID for this traffic type, and stores the AppID in the attributes storage 642. In some embodiments, the AppID is stored in the attributes storage 642 based on that flow's five-tuple identifier.

In addition to the configured operations of the service engines 650, some stages of the I/O chain collect and/or generate trace data, as well as perform other specified monitoring actions, on packets tagged by the filtering stage 660 as part of a packet tracing session (e.g., as part of a broader live traffic monitoring session). To identify which monitoring actions are specified for a packet, in some embodiments, a stage reads the set of monitoring actions to be performed from the packet's metadata stored at the computing device 605.

Additional details regarding embodiments described above and additional features of packet tracing can be found in U.S. Pat. No. 11,677,645, titled “Traffic Monitoring”, and issued Jun. 13, 2023, and U.S. Pat. No. 11,283,699, titled “Practical Overlay Network Latency Measurement in Datacenter”, and issued Mar. 22, 2022. U.S. Pat. Nos. 11,677,645 and 11,283,699 are incorporated herein by reference.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

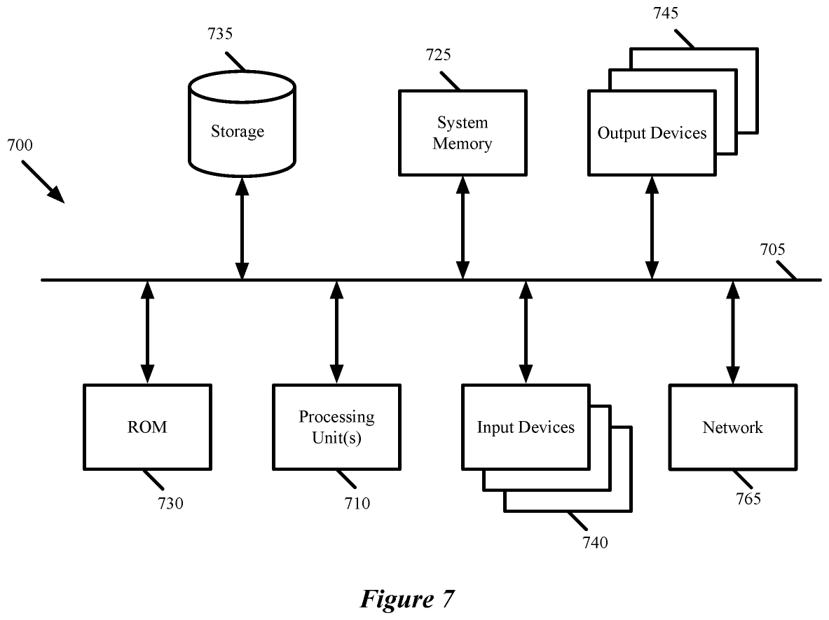

FIG. 7 conceptually illustrates a computer system 700 with which some embodiments of the invention are implemented. The computer system 700 can be used to implement any of the above-described hosts, controllers, gateway, and edge forwarding elements. As such, it can be used to execute any of the above described processes. This computer system 700 includes various types of non-transitory machine-readable media and interfaces for various other types of machine-readable media. Computer system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the computer system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) 710 may be a single processor or a multi-core processor in different embodiments. The read-only-memory (ROM) 730 stores static data and instructions that are needed by the processing unit(s) 710 and other modules of the computer system 700. The permanent storage device 735, on the other hand, is a read-and-write memory device. This device 735 is a non-volatile memory unit that stores instructions and data even when the computer system 700 is off. Some embodiments of the invention use a mass-storage device (such as a magnetic or optical disk and its corresponding disk drive) as the permanent storage device 735.

Other embodiments use a removable storage device (such as a floppy disk, flash drive, etc.) as the permanent storage device. Like the permanent storage device 735, the system memory 725 is a read-and-write memory device. However, unlike storage device 735, the system memory 725 is a volatile read-and-write memory, such as random access memory. The system memory 725 stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices 740 enable the user to communicate information and select commands to the computer system 700. The input devices 740 include alphanumeric keyboards and pointing devices (also called “cursor control devices”). The output devices 745 display images generated by the computer system 700. The output devices 745 include printers and display devices, such as cathode ray tubes (CRT) or liquid crystal displays (LCD). Some embodiments include devices such as touchscreens that function as both input and output devices 740 and 745.

Finally, as shown in FIG. 7, bus 705 also couples computer system 700 to a network 765 through a network adapter (not shown). In this manner, the computer 700 can be a part of a network of computers (such as a local area network (“LAN”), a wide area network (“WAN”), or an Intranet), or a network of networks (such as the Internet). Any or all components of computer system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of performing dynamic packet tracing in a network comprising a network controller and a plurality of host computers, each host computer comprising a set of packet processing stages for processing packet flows in the network, the method comprising:
for each packet processing stage in the set of packet processing stages at a particular host computer in the network:
providing to the packet processing stage a set of trace instructions to direct the packet processing stage to generate a set of trace data when processing packets belonging to a particular packet flow for which a packet tracing operation has been defined;
receiving from the packet processing stage the set of trace data generated during processing of a packet belonging to the particular packet flow;
determining that the set of trace instructions should be provided to a next packet processing stage in the set of packet processing stages; and
based on said determining, providing the set of trace instructions to the next packet processing stage.

2. The method of claim 1, wherein said determining is based on a set of trace rules defined for the packet tracing operation.

3. The method of claim 2, wherein said determining is further based on a set of trace control settings specified for the packet tracing operation.

4. The method of claim 2, further comprising after receiving a set of trace data from a particular packet processing stage in the set of packet processing stages, determining that based on a particular rule in the set of trace rules, the set of trace instructions should not be provided to a next packet processing stage in the set of packet processing stages.

5. The method of claim 4, wherein;
the particular rule specifies the set of trace instructions should not be provided to the next packet processing stage when disk capacity of a disk that stores a plurality of sets of trace data received from packet processing stages of the packet processing pipeline has reached a specified threshold; and
determining that based on the particular rule in the set of trace rules, the set of trace instructions should not be provided to a next packet processing stage in the set of packet processing stages comprises determining that disk capacity of the disk has reached the specified threshold.

6. The method of claim 5 further comprising based on said determining, sending a notification to the network controller indicating disk capacity of the disk has reached the specified threshold, wherein the network controller provides the notification to an administrator of the network via a UI (user interface) of the network controller.

7. The method of claim 1, wherein said determining is based on a set of trace control settings specified for the packet tracing operation.

8. The method of claim 7 further comprising:
receiving, from the network controller, a particular trace control setting specifying to stop the trace at a particular packet processing stage in the set of packet processing stages; and
after receiving a set of trace data from the particular packet processing stage, determining that the set of trace instructions should not be provided to the next packet processing stage.

9. The method of claim 8, wherein packet processing stages do not generate trace data without having received the set of trace instructions.

10. The method of claim 8, wherein determining that the set of trace instructions should not be provided to the next packet processing stage further comprises determining that the set of trace instructions should not be provided to any other subsequent packet processing stages following the particular packet processing stage.

11. The method of claim 10, wherein:
the particular host computer is a first host computer;
the next packet processing stage comprises a first packet processing stage in a packet processing pipeline of a second host computer; and
determining that the set of trace contextual data should not be provided to the next packet processing stage comprises determining that the set of trace contextual data should not be provided to the second host computer.

12. The method of claim 1 further comprising aggregating the trace data received from the set of packet processing stages to generate an aggregated set of trace metrics and providing the aggregated set of trace metrics to the network controller, wherein the network controller stores the aggregated set of trace metrics in a database of the network controller.

13. The method of claim 12, wherein the network controller displays the aggregated set of trace metrics through a user interface (UI) of the network controller.

14. The method of claim 1, wherein providing the set of trace instructions comprises providing a set of trace contextual data associated with the packet tracing operation and regarding a tracing operation performed by a prior packet processing stage.

15. The method of claim 14, wherein the set of trace contextual data comprises a unique identifier associated with the packet tracing operation and one or more span identifiers associated with each packet processing stage that has generated trace data for the packet tracing operation.

16. The method of claim 1, wherein the set of trace data comprises a rate of packets processed per minute, a percentage of failed packet processes per minute, and a duration to process a packet.

17. The method of claim 1, wherein said providing, receiving, determining, and providing are performed by an observer component that is implemented in a trace monitor deployed to the particular host computer.

18. A non-transitory machine readable medium storing a program for execution by a set of processing units of a particular host computer, the program for performing dynamic packet tracing in a network comprising a network controller and a plurality of host computers including the particular host computer, each host computer comprising a set of packet processing stages for processing packet flows in the network, the program comprising sets of instructions for:
for each packet processing stage in the set of packet processing stages at the particular host computer:
providing to the packet processing stage a set of trace instructions to direct the packet processing stage to generate a set of trace data when processing packets belonging to a particular packet flow for which a packet tracing operation has been defined;
receiving from the packet processing stage the set of trace data generated during processing of a packet belonging to the particular packet flow;
determining that the set of trace instructions should be provided to a next packet processing stage in the set of packet processing stages; and
based on said determining, providing the set of trace instructions to the next packet processing stage.

19. The non-transitory machine readable medium of claim 18, wherein said determining is based on (i) a set of trace rules defined for the packet tracing operation and (ii) a set of trace control settings specified for the packet tracing operation.

20. The non-transitory machine readable medium of claim 19, the program further comprising sets of instructions for:
receiving, from the network controller, a particular trace control setting specifying to stop the trace at a particular packet processing stage in the set of packet processing stages; and
after receiving a set of trace data from the particular packet processing stage, determining that the set of trace instructions should not be provided to any packet processing stages subsequent to the particular packet processing stage.
